(19) United States
(12) Patent Application Publication
(10) Pub. No.: US 2024/0317960 A1
(43) Pub. Date: Sep. 26, 2024

(54) POLYISOCYANURATE/POLYURETHANE FOAM COMPOSITIONS AND RELATED METHODS

(71) Applicant: Natural Polymers, LLC, Cortland, IL (US)

(72) Inventors: Benjamin J. Brown, Saint Charles, IL (US); Ernest Byron Wysong, Chadds Ford, PA (US)

(21) Appl. No.: 18/613,243

(22) Filed: Mar. 22, 2024

Related U.S. Application Data
(60) Provisional application No. 63/491,909, filed on Mar. 23, 2023.

(51) Int. Cl. C08J 9/32; C08G 18/08; C08J 3/20; C08J 9/14; C08J 9/20; C08L 75/04

(52) U.S. Cl. CPC C08J 9/32; C08G 18/0838; C08J 3/203; C08J 9/141; C08J 9/20; C08L 75/04; C08J 2203/14; C08J 2203/22; C08J 2205/05; C08J 2475/04

(57) ABSTRACT

Polymeric microspheres may be included in polyisocyanurate/polyurethane foam compositions. An exothermic foaming process and/or the application of heat during the foaming process may cause the polymeric microspheres to expand in diameter. The expanded polymeric microspheres may improve the structural properties and/or the insulating properties (e.g., R-value) of the resultant foamed PIR/PUR composition, especially an open-cell structure.

### CROSS-REFERENCE TO RELATED APPLICATIONS

This application claims priority to and all benefit of U.S. Provisional Patent Application No. 63/491,909, filed on Mar. 23, 2023, the entire disclosure of which is fully incorporated herein by reference.

### FIELD OF INVENTION

The present disclosure relates to compositions, methods, and articles that include polyisocyanurate/polyurethane (PIR/PUR) foam compositions with polymeric microspheres therein.

### BACKGROUND

PIR/PUR foams are produced by reacting a polyol and a polyisocyanate in the presence of a catalyst. While similar classes of reactants are used for producing PIR foams and PUR foams, the conditions of the reaction to form PIR foams are tailored to promote the trimerization of the polyisocyanate reactants into isocyanurate rings.

The reaction conditions used to produce PIR/PUR foams can also be tailored to favor open-cell, closed-cell or mixed-cell foams, which makes PIR/PUR foams widely applicable across different technologies including, for example, cushioning for furniture and bedding, padding for underlying carpets, acoustic materials, textile laminates, energy absorbing materials, and thermal insulation for homes and commercial buildings.

PIR/PUR foams typically are formed from two separate components, which may be referred to as an “A-side” and a “B-side,” which react when mixed. In traditional PIR/PUR foams, the first component, or the A-side, contains an isocyanate such as a di- or poly-isocyanate that has a high level of highly reactive isocyanate (—N═C═O) functional groups on the molecule. The notation of A or B in and of itself is not important; the separation of the two sides until polymerization upon mixing is the important point implied by the A and B differentiation. The second component, or B-side, typically contains nucleophilic reagents. Other components of the B-side may include surfactants, blowing agents, catalysts, and/or other auxiliary agents. The nucleophilic reagents are generally polyols having two or more hydroxyl groups, primary or secondary polyamines, and/or water. In some cases, the nucleophilic reagents include mixtures of diols and triols to achieve the desired foaming properties.

Depending on the composition of the A-side and the B-side, the resultant foamed composition may be an open-cell foam, a closed-cell foam, or a hybrid thereof. Open-cell foam compositions are lighter, but often have less structural strength and lower insulating properties as compared to closed-cell foam compositions. Attempts to improve the strength and insulating properties of foamed compositions, especially open-cell foam compositions, have included adding fillers like hollow glass beads. However, said fillers tend to increase the weight and density of the foamed compositions.

### SUMMARY OF INVENTION

The present disclosure relates to compositions, methods, and articles that include PIR/PUR foam compositions with polymeric microspheres therein.

A nonlimiting example embodiment includes a PIR/PUR foam formulation that comprises: (a) an A-side comprising an isocyanate; and (b) a B-side comprising water; a polyol composition; a catalyst; a foam-stabilizing surfactant; and a blowing agent, wherein (i) the A-side further comprises about 0.1 wt % to about 10 wt %, based on the A-side, of polymeric microspheres, (ii) the B-side further comprises about 0.1 wt % to about 10 wt %, based on the B-side, of polymeric microspheres, or (iii) both (i) and (ii).

Another nonlimiting example embodiment includes a method that comprises: mixing the A-side and the B-side of the foregoing PIR/PUR foam formulation; depositing (spraying, pouring, or injecting) the mixture on a surface; and allowing components of the A-side and the B-side to react to produce a foamed PIR/PUR composition comprising a PIR/PUR foam having expanded polymeric microspheres dispersed therein.

Another nonlimiting example embodiment includes a foamed PIR/PUR composition that comprises: a PIR/PUR foam having expanded polymeric microspheres dispersed therein.

Another nonlimiting example embodiment includes an article that comprises: a nonwoven matte having a foamed PIR/PUR composition implanted therein, the foamed PIR/PUR composition comprising a PIR/PUR foam having expanded polymeric microspheres dispersed therein.

Another nonlimiting example embodiment includes an article that comprises: two substrates; and a foamed PIR/PUR composition between the two substrates, the foamed PIR/PUR composition comprising a PIR/PUR foam having expanded polymeric microspheres dispersed therein.

These and other features and attributes of the disclosed compositions and methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings. The following figures are included to illustrate certain aspects of the disclosure, and should not be viewed as exclusive configurations. The subject matter disclosed is capable of considerable modifications, alterations, combinations, and equivalents in form and function, as will occur to those skilled in the art and having the benefit of this disclosure.

FIG. 1 is a scanning electron micrograph of foamed composition.

FIGS. 2A-2B are scanning electron micrographs of a foamed composition having expanded polymeric microspheres therein.

FIG. 3 is a scanning electron micrograph of foamed composition.

FIGS. 4A-4B are scanning electron micrographs of a foamed composition having expanded polymeric microspheres therein.

### DETAILED DESCRIPTION

The present disclosure relates to compositions, methods, and articles that include PIR/PUR foam compositions with polymeric microspheres therein. Herein, “polyurethane PIR/PUR formulation” refers to the composition before the foaming reaction, and “foamed PIR/PUR composition” refers to the composition after the foaming reaction.

More specifically, the PIR/PUR foam compositions (e.g., PIR/PUR foam formulations and foamed PIR/PUR compositions) described herein include polymeric microspheres that are capable of expanding in diameter upon heating. The PIR/PUR foam formulations of the present disclosure can be a two-part formulation that upon mixing polymerizes with an exothermic reaction, which provides at least some of the heat that enables the polymeric microspheres to expand as the polymeric microspheres become incorporated within the resultant foamed PIR/PUR composition. The expanded polymeric microspheres may improve the structural properties and/or the insulating properties (e.g., R-value) of the resultant foamed PIR/PUR composition, especially an open-cell structure. Advantageously, relatively small amounts (e.g., 10 wt % or less, or 5 wt % or less, or 3 wt % or less) of polymeric microspheres may be used to achieve the desired improved structural and/or insulating properties of the resultant foamed PIR/PUR composition.

The foamed PIR/PUR compositions described herein can advantageously be used as an insulation product, such as, for example, in residential housing (e.g., as a spray-on house wrap, as a spray-on stud facing, and the like), commercial buildings, appliances (e.g., refrigerators and ovens), hot tubs, and the like as well as cushioning for furniture and bedding, padding for underlying carpets, acoustic materials, textile laminates, energy absorbing materials, and the like.

### Methods and Articles Relating to PIR/PUR Foam Compositions

PIR/PUR foam formulations of the present disclosure may comprise: an A-side comprising an isocyanate; and a B-side comprising water, a polyol composition, a catalyst, a foam-stabilizing surfactant, and a blowing agent. The polymeric microspheres may be in either of or both of A-side and B-side. Details of each of these components is provided in more detail below. Generally, the A-side and the B-side are kept separate until mixing, which brings the two sides into contact to initiate the polymerization reaction. The mixing typically occurs while or just before placement of the mixture in the desired location. For example, in spray foam applications, the A-side and B-side may be mixed in a nozzle or other portion of the spraying apparatus. In another example, the A-side and B-side may be mixed before (e.g., seconds to minutes before) placement (e.g., pouring onto or into) on a conveyor belt, in a mold, on a substrate, or the like. In yet another example, the A-side and B-side may be mixed before (e.g., seconds to minutes before) injection into a nonwoven substrate, netting, fabric, or the like.

As the A-side and B-side components react, the blowing agent aids the foaming of the PIR/PUR foam formulation. The foaming continues until the blowing agent is consumed and/or the reaction, which is exothermic, causes the resultant polymer to set (become sufficiently rigid to not expand further). The exothermic nature of the reaction provides at least some of the heat that causes the polymeric microspheres to expand while the PIR/PUR foam formulation is foaming into the foamed PIR/PUR compositions. The exothermic reaction preferably produces enough heat to heat the polymeric microspheres to about 50° C. to about 235° C. (or about 80° C. to about 180° C., or about 100° C. to about 150° C.) to cause the polymeric microspheres to expand but not cause significant degradation of the polymeric shell.

Without being limited by theory, it is believed that when using PIR/PUR foam formulation that set quickly, the amount of expansion of the polymeric microspheres may be limited by the available space within the set (or setting) insulation (i.e., the foamed PIR/PUR composition). Accordingly, in at least some embodiments, the expanded polymeric microspheres may provide a bridge between foam cells, which is supported by scanning electron microscopy (SEM) images showing polymeric microspheres in the cell walls (especially at the intersection of cell walls) of the foamed composition. It is believed that the polymeric microspheres maintain closed structures. As such, it is believed that these microspheres create bridges within the foamed structure that may act as a reinforcing agent and improve the structural properties (e.g., compressive and tensile strength) of the resultant foamed PIR/PUR composition and may also improve the insulating properties (e.g., the polymeric microspheres acting to minimize, reduce, or interrupt heat conduction along the cell walls) of the resultant foamed PIR/PUR composition. Further, depending on the formulation, the inclusion of polymeric microspheres may decrease the cell size in the foamed PIR/PUR composition as compared to the same formulation without polymeric microspheres. The smaller cell size may further improve the structural and insulation properties. Advantageously, the expanded polymeric microspheres have a low density (e.g., 0.1 g/cm³ or less) and may be used in a low concentration (e.g., 10 wt % or less, or 5 wt % or less, or 3 wt % or less), so the weight and density increase to the resultant foamed PIR/PUR composition may be minimal.

A method forming the foamed PIR/PUR compositions described herein may include: mixing the A-side and the B-side of the PIR/PUR foam formulation described herein; depositing (e.g., spraying, pouring, injecting, and the like) the mixture on a surface; and allowing components of the A-side and the B-side to react to produce a foamed PIR/PUR composition comprising a PIR/PUR foam having expanded polymeric microspheres dispersed therein.

The PIR/PUR foam formulation described herein may be used in high-pressure spray foam methods and low-pressure spray foam methods. The difference between the two methods includes the rate at which the foam is applied to a surface. Generally, in high-pressure methods, the application rate is much higher than in low-pressure methods.

High-pressure spraying methods may be used, for example, when foam needs to be placed over large areas like home insulation and commercial building insulation applications. In high-pressure spray foam, for example, the components of the A-side and the components of the B-side can be delivered through separate lines into a spray device, such as an impingement-type spray gun. The two components can be pumped through orifices at high pressure to form streams of the individual components of the A-side and the B-side (the B-side including the polymeric microspheres). When the A-side and B-side streams mix with each other, the polymerization reaction begins. The mixture can be deposited on (or sprayed onto) a surface (e.g., wood, metal, cement, polymer composite, a fabric batting, a polymer barrier material, or the like). Said surface may be a surface being insulated, for example, in an attic or between walls. Further, said surface may be part of a mold used to produce a molded foamed PIR/PUR composition.

Low-pressure spraying methods are used, for example, when applying foams to or in smaller spaces including filling cracks or gaps and covering small surface areas. Similar to high-pressure spraying, low-pressure spraying methods and systems keep the components of the A-side and the components of the B-side separated until spraying. The difference is, however, that the pressure used to convey and mix the two sides is lower with the low-pressure spraying methods and systems. Again, when the A-side and B-side streams mix with each other, the polymerization reaction begins. The mixture can be deposited on (or sprayed onto) a surface (e.g., wood, metal, cement, polymer composite, a fabric batting, a polymer barrier material, or the like).

In another example of forming foamed PIR/PUR compositions described herein, the A-side and the B-side of the PIR/PUR foam formulation described herein can be mixed and poured onto a surface on which the components of the A-side and the B-side react to produce a foamed PIR/PUR composition comprising a PIR/PUR foam having expanded polymeric microspheres dispersed therein. The surface may be a moving substrate (e.g., a conveyor belt or a substrate on a conveyor belt or a mold on a conveyor belt). Said methods may be used for producing foams that are then cut into desired dimensions, producing foam boards, and the like. For example, a foam board may be produced by depositing the PIR/PUR foam formulation (the mixture of the A-side and the B-side) on a substrate (e.g., a polymer film, a paper substrate, a cardboard substrate, a wood or wood composite substrate, and the like) and, optionally, adding a second substrate to the other side of the PIR/PUR foam formulation as the foaming (or reaction of the A-side and the B-side components) is occurring. When the second substrate is used, the resultant board has a sandwich configuration with the PIR/PUR foam having expanded polymeric microspheres dispersed therein being between the two substrates.

In yet another example of forming foamed PIR/PUR compositions described herein, the A-side and the B-side of the PIR/PUR foam formulation described herein can be mixed and injected into a porous material (e.g., a nonwoven substrate, netting, fabric, or the like). As the components of the A-side and the B-side react, the PIR/PUR foam expands to fill at least some of the voids (or interstitial space) within the porous material.

The polymeric microspheres in the foamed PIR/PUR compositions described herein may have a number average diameter of about 10 μm to about 300 μm (or about 10 μm to about 50 μm, or about 25 μm to about 100 μm, or about 50 μm to about 200 μm, or about 100 μm to about 250 μm, or about 150 μm to about 300 μm). The diameter of the polymeric microspheres may be determined, for example, using techniques known in the art such as scanning electron microscopy (SEM) with a minimum of 200 measurements.

Polymeric microspheres may be present in the foamed PIR/PUR compositions in an amount of about 0.05 wt % to about 8 wt % (or about 0.05 wt % to about 3 wt %, or about 2 wt % to about 4 wt %, or about 3 wt % to about 6 wt %, or about 4 wt % to about 8 wt %) based on a total weight of the foamed PIR/PUR composition.

The foamed PIR/PUR compositions described herein may comprise a PIR/PUR foam having open cells, closed cells, or a combination thereof. Preferably, the PIR/PUR foam formulations described herein produce open-cell foam compositions wherein the polymeric microspheres expand as the PIR/PUR foam formulation sets. As used herein, an “open-cell” foam refers to a foam where greater than 90% of the foam's cells (by number of total cells) are open. As used herein, a “closed-cell”foam refers to a foam where greater than 90% of the foam's cells (by number of total cells) are closed. As used herein, a “hybrid-cell” foam refers to a foam with both open and closed cells that do not fall within the definitions of open-cell foam or closed-cell foam. Preferably, hybrid cell foams have 50% to 90% (by number of total cells) open cells. The nature of the cells in the foam may change the properties of the foamed PIR/PUR composition.

The thermal insulation properties of a foamed PIR/PUR composition may be characterized by an R-value, which is measured according to ASTM C518-21. An open-cell foamed PIR/PUR composition described herein may have an R-value of about 3 per inch to about 5 per inch. A closed-cell foamed PIR/PUR composition described herein may have an R-value of about 6 per inch to about 10 per inch. A hybrid-cell foamed PIR/PUR composition described herein may have an R-value of about 3 per inch to about 10 per inch.

The foamed PIR/PUR compositions described herein, independent of the cell structure, may have an R-value increase (as compared to a comparable foamed PIR/PUR composition, i.e., a foamed PIR/PUR composition produced with the same PIR/PUR foam formulation but without the polymeric microspheres and via the same method) of about 2% or more (or about 2% to about 10%, or about 2% to about 6%, or about 4% to about 10%). The R-value increase can be calculated by (R_{PMS}−R_{C})/R_{C}*100 where R_{PMS} is the R-value of the foamed PIR/PUR compositions described herein having the polymeric microspheres dispersed therein and the Re is the R-value of a foamed PIR/PUR composition that does not include the polymeric microspheres but is otherwise identical.

The foamed PIR/PUR compositions described herein may have an apparent density (ASTM D1622-20) of about 0.5 lb/ft³ to about 5 lb/ft³ (about 0.5 lb/ft³ to about 3 lb/ft³, or about 2 lb/ft³ to about 5 lb/ft³)).

The mechanical properties of a foamed PIR/PUR composition may be characterized by a compressive strength, which is measured according to ASTM D1621.

An open-cell foamed PIR/PUR composition described herein may have a compressive strength of about 2 psi to about 20 psi (or about 2 psi to about 10 psi, or about 5 psi to about 15 psi, or about 10 psi to about 20 psi). A closed-cell foamed PIR/PUR composition described herein may have a compressive strength of about 10 psi to about 100 psi (or about 10 psi to about 50 psi, or about 25 psi to about 75 psi, or about 50 psi to about 100 psi). A hybrid-cell foamed PIR/PUR composition described herein may have a compressive strength of about 2 psi to about 100 psi (or about 2 psi to about 10 psi, or about 5 psi to about 15 psi, or about 10 psi to about 20 psi, or about 10 psi to about 50 psi, or about 25 psi to about 75 psi, or about 50 psi to about 100 psi).

The foamed PIR/PUR compositions described herein, independent of the cell structure, may have a compressive strength increase (as compared to a comparable foamed PIR/PUR composition) of about 5% or more (or about 5% to about 40%, or about 10% to about 30%, or about 15% to about 40%). The compressive strength increase can be calculated by (CS_{PMS}−CS_{C})/CS_{C}*100 where CS_{PMS} is the compressive strength of the foamed PIR/PUR compositions described herein having the polymeric microspheres dispersed therein and the CS_{C} is the compressive strength of a foamed PIR/PUR composition that does not include the polymeric microspheres but is otherwise identical.

### Components of PIR/PUR Foam Formulations

Any known combination of isocyanates in A-side and polyols in B-side may be used.

Examples of isocyanates suitable for use in A-side may include, but are not limited to, diphenylmethane 4,4-diisocyanate (“MDI”), naphthalene 1,5-diisocyanate (“NDI”), 2,4-toluene diisocyanate (“TDI”), 2,6-TDI, hexamethylene diisocyanate (“HDI”), isophorone diisocyanate, dicyclohexylmethane-4,4′-diisocyanate, 1,4-tetramethylene diisocyanate, 1,5-pentamethylene diisocyanate, 1,7-heptamethylene diisocyanate, 1,8-octamethylene diisocyanate, 1,9-nonamethylene diisocyanate, 1,10-decamethylene diisocyanate, 2,2,4-trimethyl-1,5-pentamethylene diisocyanate, 2,2′-dimethyl-1,5-pentamethylene diisocyanate, 3-methoxy-1,6-hexamethylene diisocyanate, 3-butoxy-1,6-hexamethylene, omega, omega′-dipropylether diisocyanate, 1,4-cyclohexyl diisocyanate, 1,3-cyclohexyl diisocyanate, trimethylhexylmethylene diisocyanate, 2,4′-diphenylmethane diisocyanate, 2,2′-diphenylmethane diisocyanate, 3,3′-dimethyl-4,4′-biphenylene diisocyanate, 3,3′-dimethoxy-4,4′-biphenylene diisocyanate, 3,3′-dichloro-4,4′-biphenylene diisocyanate, 1,5-naphthalene diisocyanate, 1,5-tetrahydronaphthalene diisocyanate, tetramethylene diisocyanate, 1,6-hexamethylene diisocyanate, dodecamethylene diisocyanate, trimethylhexamethylene diisocyanate, 1,3-cyclohexylene diisocyanate, 1,4-cyclohexylene diisocyanate, xylylene diisocyanate, tetramethylxylylene diisocyanate, hydrogenated xylylene diisocyanate, lysine diisocyanate, isophorone diisocyanate, 4,4′-dicyclohexylmethane diisocyanate, 3,3′-dimethyl-4,4′-dicyclohexylmethane diisocyanate, isomers thereof, the like, and any combination thereof.

Isocyanates may be present in the A-side in an amount of about 40 wt % to about 100 wt % (or about 40 wt % to about 90 wt %, or about 40 wt % to about 60 wt %, or about 50 wt % to about 85 wt %, or about 65 wt % to about 80 wt %, or about 60 wt % to about 90 wt %) based on a total weight of the A-side.

Suitable polyols for the B-side may include glycerin-sucrose polyols, Mannich polyols, and aromatic polyester polyols, the like, and any combination thereof. Glycerin-sucrose polyols are commonly made by reacting an initiator mixture of desired average hydroxyl functionality with one or more epoxides (e.g., ethylene oxide, propylene oxide, or their combinations) in the presence of a basic or metal complex catalyst. Mannich polyols are typically reaction products of a phenol (especially alkylated phenols), formaldehyde, and an alkanolamine (i.e., a “Mannich base”) in which the free hydroxyl groups of the Mannich base are further reacted with one or more epoxides (especially ethylene oxide, propylene oxide, or their combinations). Examples of Mannich polyols are provided in U.S. Pat. No. 6,495,722, the relevant disclosure of which is incorporated herein by reference. Aromatic polyester polyols are well-known reaction products of an aromatic dicarboxylic acid or anhydride (e.g., terephthalic acid, phthalic anhydride) and a diol (e.g., propylene glycol, diethylene glycol).

Examples of other polyol compositions suitable for use in the compositions and methods described herein may include, but are not limited to, polyether polyols, polyester polyols, the like, and any combination thereof.

An example of a suitable polyether polyol includes the polymerization product of an alkylene oxide or a mixture of alkylene oxides (e.g., ethylene oxide or propylene oxide) with a polyhydric alcohol initiator, such as, but not limited to ethylene glycol; 1,2-propylene glycol; 1,3-propylene glycol; 1,4-butylene glycol; 1,2-butylene glycol; 2,3-butylene glycol; 1,6-hexane diol; 1,8-octane diol; neopentyl glycol; cyclohexane dimethanol (1,4-bis-hydroxymethyl cyclohexane) 2-methyl-1,3-propane diol; glycerol; trimethylol propane; 1,2,6-hexane triol; 1,2,4-butane triol; trimethylol ethane; pentaerythritol; quinitol; mannitol; sorbitol; methyl glycoside; diethylene glycol; triethylene glycol; tetracthylene glycol; polyethylene glycol; propylene glycol; dipropylene glycol; polypropylene glycols; dibutylene glycol; polybutylene glycols; cyclohexane dimethanol; resorcinol; glycerol; and the like. In addition, compounds derived from phenols such as 2,2-bis(4-hydroxylphenyl)propane, commonly known as Bisphenol A, may be used to react with the alkylene oxide(s) to form a polyether polyol.

Polyester polyols suitable for use in the present disclosure may be prepared by the condensation of an alkene glycol and a corresponding diether or diacid. One example is the reaction of 1,4-butanediol with adipic acid to form polybutanediol adipate. Any suitable polycarboxylic acid may be used to form the polyester polyol. Non-limiting examples of polycarboxylic acids include oxalic acid, malonic acid, succinic acid, glutaric acid, adipic acid, pimelic acid, suberic acid, azelaic acid, sebacic acid, brassylic acid, thapsic acid, maleic acid, fumaric acid, glutaconic acid, α-hydromuconic acid, β-hydromuconic acid, α-butyl-α-ethyl-glutaric acid, α, β-diethylsuccinic acid, isophthalic acid, terephthalic acid, hemimellitic acid, dimethylol propionic acid, and 1,4-cyclohexanedicarboxylic acid. A polyhydric alcohol initiator such as ethylene glycol; 1,2-propylene glycol; 1,3-propylene glycol; 1,4-butylene glycol; 1,2-butylene glycol; 2,3-butylene glycol; 1,6-hexane diol; 1,8-octane diol; neopentyl glycol; cyclohexane dimethanol (1,4-bis-hydroxymethyl cyclohexane) 2-methyl-1,3-propane diol; glycerol; trimethylol propane; 1,2,6-hexane triol; 1,2,4-butane triol; trimethylol ethane; pentaerythritol; quinitol; mannitol; sorbitol; methyl glycoside; diethylene glycol; triethylene glycol; tetraethylene glycol; polyethylene glycol; propylene glycol; dipropylene glycol; polypropylene glycols; dibutylene glycol; polybutylene glycols; cyclohexane dimethanol; resorcinol; bisphenol A; glycerol, and mixtures thereof may also be used to form the polyester polyol.

Examples of commercially available polyols may include, but are not limited to, CARPOL® GSP-355 (a glycerin-sucrose polyol, available from Carpenter), CARPOL® GSP-520 (a glycerin-sucrose polyol, available from Carpenter), CARPOL® MX-425 (a Mannich polyol, available from Carpenter), CARPOL® MX-470 (a Mannich polyol, available from Carpenter), VORANOL™ 370 (a glycerin-sucrose polyol, available from Dow), VORANOL™ 490 (a glycerin-sucrose polyol, available from Dow), VORANOL™ 425XL (a Mannich polyol, available from Dow), VORANOL™ 470X (a Mannich polyol, available from Dow), PLURACOL® SG-360 (a glycerin-sucrose polyol, available from BASF), JEFFOL® R-425X (a Mannich polyol, available from Huntsman), JEFFOL® R-470X (a Mannich polyol, available from Huntsman), TEROL® 250 (an aromatic polyol, available from Huntsman), TEROL® 305 (an aromatic polyol, available from Huntsman), TEROL® 64 (an aromatic polyol, available from Huntsman), STEPANPOL® PS-2520 (an aromatic polyol, available from Stepan Company), STEPANPOL® PS-3021 (an aromatic polyol, available from Stepan Company), STEPANPOL® 3152 (an aromatic polyol, available from Stepan Company), TERATE® 2541 (an aromatic polyol, available from Invista), TERATE® 3510 (an aromatic polyol, available from Invista), Coim (ISOEXTER® TB-305 (an aromatic polyol, available from Coim), ISOEXTER® TB-306 (an aromatic polyol, available from Coim), the like, and any combination thereof.

Polyol compositions may be present in an amount of about 40 wt % to about 90 wt % (or about 40 wt % to about 60 wt %, or about 50 wt % to about 85 wt %, or about 65 wt % to about 80 wt %, or about 60 wt % to about 90 wt %) based on a total weight of the B-side.

Catalysts may be included in the B-side compositions described herein to perform one or more functions to: (a) catalyze the reaction between water and the polyisocyanate to form polyureas, (b) promote trimerization of the polyisocyanate, and (c) promote the reaction of polyols and polyisocyanates.

Examples of catalysts suitable for use in the compositions and methods described herein may include, but are not limited to, carboxylates (e.g., potassium acetate, potassium octoate), organotin compounds (e.g., dibutyltin dilaurate, stannous octoate), quaternary ammonium compounds (e.g., N-(2-hydroxyethyl)trimethylammonium chloride), tertiary amines (e.g., triethylenediamine, N-methylmorpholine, N-ethylmorpholine, diethylethanolamine, N-cocomorpholine, 1-methyl-4-dimethylaminoethylpiperazine, 3-methoxypropyldimethylamine, N,N,N′-trimethyl isopropyl propylenediamine, 3-diethylaminopropyldiethylamine, and dimethylbenzylamine), bis(2-dimethylaminoethyl)ether, N,N-dimethylaminopropylamine, N,N-dimethylethanolamine, triethylenediamine, benzyldimethylamine, N,N-dimethylcyclohexylamine, N,N,N′,N′,N″-pentamethyldiethylenetriamine, diethanolamine, N-ethylmorpholine, N,N,N′N′-tetramethylbutanediamine, 1,4-diaza[2.2.2]bicyclooctane, tin, dibutyltin mercaptide, potassium octoate, potassium acetate, bismuth, bismuth carboxylate mixtures, the like, and any combination thereof.

Commercial examples of suitable catalysts may include, but are not limited to, POLYCAT® 5 (pentamethyldiethylenetriamine, available from Evonik), POLYCAT® 8 (N,N-dimethylcyclohexylamine, available from Evonik), POLYCAT® 30 (available from Evonik), POLYCAT® 36 (available from Evonik), POLYCAT® 41 (available from Evonik), POLYCAT® 46 (available from Evonik), POLYCAT® 77 (available from Evonik), CURITHANE® 52 (2-methyl(n-methyl amino b-sodium acetate nonyl phenol, available from Evonik), DABCO® 2039 (available from Evonik), DABCO® 204 (available from Evonik), DABCO® 2040 (available from Evonik), DABCO® BL-19 (available from Evonik), DABCO® BL-17 (available from Evonik), DABCO® T (available from Evonik), DABCO® T-125 (available from Evonik), DABCO® K-15 (available from Evonik), Dabco® TMR (available from Evonik), DABCO® TMR-2 (available from Evonik), DABCO® TMR-3 (available from Evonik), DABCO® TMR-30 (available from Evonik), BICAT® 8210 (available from The Shepard Chemical Company), BICAT® 8840 (available from The Shepard Chemical Company), BICAT® 8842 (available from The Shepard Chemical Company), K-KAT® XK 651 (available from King Industries), K-KAT® 614 (available from King Industries), K-KAT® 672 (available from King Industries), K-KAT® 604 (available from King Industries), NIAX® UL1 (available from Momentive Performance Materials Inc.), NIAX® UL22, NIAX® UL1 (available from Momentive Performance Materials Inc.), JEFFAMINE® D-230 (available from Huntsman), JEFFAMINE® T403 (available from Huntsman), JEFFAMINE® D2000 (available from Huntsman), JEFFAMINE® T5000 (available from Huntsman), JEFFCAT® PMDETA (available from Huntsman), JEFFCAT® DMCHA (available from Huntsman), ZF20 (available from Huntsman), ZF54 (available from Huntsman), DABCO® T-12 (metal catalyst, available from Evonik), DABCO® T-120 (metal catalyst, available from Evonik), KOSMOS® (metal catalyst, available from Evonik), K-KAT® (catalyst, available from King Industries), and FOMREZ® (organotin catalyst, available from Galata Chemicals).

The amount of catalyst needed may depend on the selection of the catalyst used, the nature of the other components, the NCO/OH index, the desired foam density, and other factors. If used, a catalyst may be present in an amount of about 0.01 wt % to about 5 wt % (or about 0.01 wt % to about 0.1 wt %, or about 0.05 wt % to about 0.4 wt %, or about 0.1 wt % to about 1 wt %, or about 0.1 wt % to about 2 wt %, or about 0.5 wt % to about 4 wt %, or about 1 wt % to about 3 wt %, or about 2 wt % to about 5 wt %) based on a total weight of the B-side.

The B-side may also include a foam-stabilizing surfactant. Examples of foam-stabilizing surfactants suitable for use in the compositions and methods described herein may include, but are not limited to, polyethylene glycol ether of a C₈-C₃₀ alcohol, tertiary amine of a C₈-C₃₀ alkyl acid sulfate ester, alkanolamine salt of a C₈-C₃₀ alkyl acid sulfate ester, tertiary amine of a C₈-C₃₀ alkyl sulfonic ester, alkanolamine salt of a C₈-C₃₀ alkyl sulfonic ester, and tertiary amine of a C₈-C₃₀ alkyl arylsulfonic acid, alkanolamine salt of a C₈-C₃₀ alkyl arylsulfonic acid, silicone surfactant, silicone polyether surfactant, the like, and any combination thereof. Examples of commercially available surfactants may include DABCO® DC 197 (a silicone glycol copolymer, available from Air Products), DABCO® DC 5098 (a silicone glycol copolymer, available from Air Products), DABCO® 120 (a silicone glycol copolymer, available from Air Products), TEGOSTAB® B (silicone surfactants, available from Evonik) SILSTAB® (silicone surfactants, available from Siltech), VORASURF™ (silicone surfactants, available from DOW), and NIAX® (silicone surfactants, available from Momentive).

If used, a foam-stabilizing surfactant may be present in an amount of about 0.01 wt % to about 3 wt % (or about 0.01 wt % to about 2 wt %, or about 0.05 wt % to about 1 wt %, or about 0.2 wt % to about 0.7 wt %, or about 1 wt % to about 3 wt %) based on a total weight of the B-side.

The B-side may also include a blowing agent. Generally, a blowing agent is used to give off a gas or expand to fill polymeric cells of the foam. The blowing agent may be a single chemical compound (e.g., a low boiling point hydrocarbon or halogenated hydrocarbon like a fluorocarbon) that generates a gas upon heating, irradiation, or photo initiation; two or more chemicals that form a gas upon mixing; or a phase change blowing agent.

Preferably, the blowing agent is non-reactive with other components of the composition. In preferred examples, the blowing agent is also environmentally friendly and has zero or very little ozone depletion potential (ODP) and little to no global warming potential (GWP).

In some instances, the blowing agent may be a chemical compound that, when heat or light activated, forms a gas. The generated gas may be N₂, O₂, H₂, or other non-carcinogenic, gases. For instance, azodicarbonamide is a chemical compound that, upon heating, releases N₂ gas, and would be a suitable blowing agent in the PIR/PUR foam formulation. Additionally, alkylsiloxanes, such as XIAMETER®, and MHX-1107 Fluid (all available from Dow Corning), which may release H₂ when reacting with amine hardeners, may be used as a blowing agent and/or as a crosslinking agent in the present disclosure. Other examples include diazo compounds (e.g., CH₂N₂) and aliphatic azide (e.g., R—N═N═N), which decompose on irradiation to give nitrogen gas.

Blowing agents suitable for use (in addition to the water, which generates carbon dioxide when reacted with polyisocyanates) may include, but are not limited to, aliphatic or cycloaliphatic C₄-C₆ hydrocarbons, mono- and polycarboxylic acids and their salts, tertiary alcohols, carbon dioxide, hydrofluorocarbons (HFCs), hydrochlorofluorocarbons (HCFCs), halogenated hydrocarbons, hydrofluoroethers (HFEs), hydrochlorofluoroolefins (HCFOs), hydrofluoroolefins (HFOs), and the like, and their mixtures. Examples of suitable blowing agents may include those disclosed in U.S. Pat. Nos. 6,359,022, 9,868,837, and WO/2019/213463, which are incorporated herein by reference. Examples of blowing agents suitable for use in the compositions and methods described herein may include, but are not limited to, methyl fluoride, difluoromethane (HFC-32), perfluoromethane, ethyl fluoride (HFC-161), 1,2-difluoroethane (HFC-142), 1,1-difluoroethane (HFC-152a), 1,1,1-trifluoroethane (HFC-143a), 1,1,1,2-tetrafluoro-ethane (HFC-134a), 1,1,2,2-tetrafluoroethane (HFC-134), pentafluoroethane (HFC-125), perfluoroethane, 2,2-difluoropropane (HFC-272fb), 1,1,1-trifluoropropane (HFC-263fb), 1,1,1,3,3-pentafluoropropane (HFC 245fa), 1,1,1,2,3,3,3-heptafluoropropane (HFC-227ca), perfluoropropane, 1,1,1,3,3-pentafluorobutane (HFC-365mfc), perfluorobutane, and perfluorocyclobutane. Examples of partially halogenated chlorocarbons and mixed, chlorofluorocarbons for use in present disclosure include methyl chloride, methylene chloride, chlorodifluoromethane (HCFC-22), ethyl chloride, 1,1,1-trichloroethane, 1,1,1-trifluoroethane, 1,1-dichloro-1-fluorocthanc (HCFC-141b), 1-chloro-1,1-difluoroethane (HCFC-142b), 1,1-dichloro-2,2,2-trifluoroethane (HCFC-123), 1-chloro-1,2,2,2-tetrafluoroethane (HCFC-124), pentafluoroethane, dichloropropane, trichloromonofluoromethane (CFC-11), dichlorodifluoromethane (CFC-12), trichlorotrifluoroethane (CFC-113), dichlorotetrafluoroethane (CFC-114), chloroheptafluoropropane, dichlorohexafluoropropane, 1,1,1,4,4,4-hexafluoro-2-butene (OPTEON™ 1100, available from Chemours), the like, and any combination thereof.

The amount of blowing agent needed may depend on many factors within the skilled person's discretion, including the nature of the other components, the NCO/OH index, the desired foam density and properties, and other factors. Generally, blowing agents may be present in an amount of about 5 wt % to about 15 wt % (or about 5 wt % to about 10 wt %, or about 8 wt % to about 12 wt %, or about 10 wt % to about 15 wt %) based on a total weight of the B-side.

Suitable polymeric microspheres for inclusion in the A-side, the B-side, or both may comprise a volatile component encapsulated in a polymeric shell.

Examples of volatile components may be C₃₋₇ hydrocarbons (i.e., hydrocarbons having 3 to 7 carbons). Examples of C₃₋₇ hydrocarbons may include, but are not limited to, butane, pentane, hexane, heptane, isobutene, isopentane, neopentane, cyclopropane, cyclobutane, cyclopropane, the like, and any combination thereof.

Suitable polymeric materials for the polymeric microspheres include acrylic-based monomers. For example, an acrylonitrile copolymer may be used to form the polymer shell. An example acrylonitrile copolymer suitable for use in the polymer shell is an acrylonitrile acrylic ester olefin copolymer, which is the copolymer polymerization product of acrylonitrile monomers, acrylic ester (or acrylate) monomers, and olefin monomers). Examples of acrylonitrile monomers may include, but are not limited to, acrylonitrile, methacrylonitrile, and any combination thereof. Examples of suitable acrylate monomers may include, but are not limited to, C₁₋₂₅ alkyl acrylates, C₁₋₂₅ alkyl methacrylates, aromatic acrylates, aromatic methacrylates, di-acrylate, di-methacrylate, isobornyl acrylate, isobornyl methacrylate, oligomeric acrylate, oligomeric methacrylate, the like, and any combination thereof. Examples of olefin monomers may include, but are not limited to, styrene, o-methylstyrene, m-methylstyrene, p-methylstyrene, ethylstyrene, vinyl-xylene, chlorostyrene, bromostyrene, the like, and any combination thereof.

Examples of commercially available polymeric microspheres suitable for use in the compositions and methods described herein may include, but are not limited to, ADVANCELL® EML101 (expandable microspheres available from AdvanCell), ADVANCELL® EML204 (expandable microspheres available from AdvanCell), ADVANCELL® EML302 (expandable microspheres available from AdvanCell), ADVANCELL® EML303 (expandable microspheres available from AdvanCell), ADVANCELL® EML306 (expandable microspheres available from AdvanCell), ADVANCELL® EML307 (expandable microspheres available from AdvanCell), ADVANCELL® EML403 (expandable microspheres available from AdvanCell), ADVANCELL® EML406 (expandable microspheres available from AdvanCell), ADVANCELL® EML501 (expandable microspheres available from AdvanCell), ADVANCELL® EML504 (expandable microspheres available from AdvanCell), EXPANCEL® DE (expandable microspheres available from Nouryon), EXPANCEL® WE (expandable microspheres available from Nouryon), the like, and any combination thereof.

The polymeric microspheres may have a number average diameter (before expansion) of about 1 μm to about 100 μm (or about 1 μm to about 20 μm, or about 1 μm to about 50 μm, or about 10 μm to about 75 μm, or about 25 μm to about 60 μm, or about 50 μm to about 100 μm). The polymeric microspheres may be capable of expanding to have a number average diameter (an expanded number average diameter) of about 25 μm to about 300 μm (or about 25 μm to about 100 μm, or about 50 μm to about 150 μm, or about 100 μm to about 200 μm, or about 150 μm to about 250 μm, or about 200 μm to about 300 μm).

The polymeric microspheres may have a density (after expansion) of about 0.1 g/cm³ or less (or about 0.001 g/cm³ to about 0.1 g/cm³, or about 0.001 g/cm³ to about 0.05 g/cm³, or about 0.001 g/cm³ to about 0.01 g/cm³, or about 0.01 g/cm³ to about 0.05 g/cm³).

Polymeric microspheres may be present in an amount of about 0.1 wt % to about 10 wt % (or about 0.1 wt % to about 3 wt %, or about 2 wt % to about 4 wt %, or about 3 wt % to about 6 wt %, or about 4 wt % to about 8 wt %, or about 5 wt % to about 10 wt %) based on a total weight of the side (A-side formulation or B-side formulation) in which the polymeric microspheres are present.

Water may be present in the B-side of the PIR/PUR foam formulation in an amount of about 0.5 wt % to about 5 wt % (or about 0.5 wt % to about 3 wt %, or about 1 wt % to about 4 wt %, or about 2 wt % to about 3 wt %, or about 3 wt % to about 5 wt %) based on a total weight of the B-side.

In the PIR/PUR foam formulation described herein, the A-side or B-side may also include other optional, additional components or additives such as, for example, foam promoters, opacifiers, pigments, accelerators, foam stabilizers (or cell stabilizers), color indicators, gelling agents, flame retardants, biocides, fungicides, algaecides, corrosion inhibitors, fillers, antioxidants, odor scavengers, pest inhibitors, chain extenders, epoxy resins, acrylic resins, the like, and any combination thereof.

If used, each additive may independently be present in an amount of about 0.1 wt % to about 10 wt % (or about 0.1 wt % to about 2 wt %, or about 1 wt % to about 5 wt %, or about 3 wt % to about 8 wt %, or about 4 wt % to about 7 wt %, or about 5 wt % to about 10 wt %) based on a total weight of the side (A-side formulation or B-side formulation) in which the flame retardants are present.

Pigments may be inorganic pigments, organic pigments, extender pigments, or any combination thereof. Examples of inorganic pigments may include, but are not limited to, carbon black, titanium dioxide, zinc oxide, aluminum oxide, magnesium oxide, antimony trioxides, cuprous oxides, iron oxides, chromium oxides, zinc sulfides, cadmium sulfides, cadmium selenides, lead chromate, ultramarine blue, the like, and any combination thereof. Examples of organic pigments may include, but are not limited to, azo, anthraquinone, benzidine, benzimidazolone, dianisidine, diazo, phthalocyanine, quinacridone, dioxazine, isoindolinone pigments, the like, and any combination thereof. Examples of extender pigments may include, but are not limited to, clay, calcium carbonate, talc, bentonite, kaolin, mica, silica, barium sulfate, barium carbonate, the like, and any combination thereof.

Examples of accelerators may include, but are not limited to, charcoal, activated carbon, diamonds, fullerenes, graphites, coke, coal, carbon black, the like, and any combination thereof.

Organopolysiloxanes and silicone surfactants may be used as foam stabilizers.

Examples of gelling agents may include, but are not limited to, alginate containing hydrogel powder, acacia, alginic acid, bentonite, carboxymethyl cellulose, ethylcellulose, gelatin, hydroxyethylcellulose, hydroxypropyl cellulose, magnesium aluminum silicate, methylcellulose, poloxamers, polyvinyl alcohol, sodium alginate, tragacanth, hyaluronan, polyethylene, carrageenans, polypropylene glycol, agar and polyvinylpyrrolidone, polyacrylic acid, hydrocolloid polyesters, chitosen, collagen, xanthan gum, the like, and any combination thereof.

Examples of flame retardants may include, but are not limited to, tris(chloroethyl) phosphate, tris(2-chloroethyl) phosphate, tris(dichloropropyl) phosphate, tris(2-chloropropyl) phosphate, tris(1-chloro-2-propyl) phosphate (TCPP), tris(2,3-dibromopropyl) phosphate, tris(1,3-dichloropropyl) phosphate, diammonium phosphate, halogenated aromatic compounds, antimony oxide, aluminum trihydrate, polyvinyl chloride, bromine-containing diester/ether diols of tetrabromophthalic anhydride, such as a mixed ester of tetrabromophthalic anhydride with diethylene glycol and propylene glycol, chlorinated paraffins, phosphorus-containing polyols, and brominated aromatic compounds such as pentabromodiphenyl oxide, brominated polyols, the like, and any combination thereof. An example of a commercially available flame retardant is SAYTEX® RB-79 (a reactive bromine-containing diester/ether diol of tetrabromophthalic anhydride, available from Albemarle Corporation).

Examples of suitable biocides may include, but are not limited to, 3-iodo-2propyl-n-butylcarbamate, carbamic acid, butyl-, 3-iodo-2-propynyl ester (IPBC), 2-bromo-2-nitropropane-1,3-diol, magnesium nitrate, 5-chloro-2-methyl-4-isothiazolin-3-one, magnesium chloride, sulfamic acid, N-bromo, sodium salt, diiodomethyl-p-tolysulfone, dibromoacetonitrile, and 2,2-dibromo-3-nitrilopropionamide, the like, and any combination thereof.

Examples of suitable corrosion inhibitors may include, but are not limited to, tin oxalate, tin sulfate, tin chloride, thiourea, the like, and any combination thereof.

Examples of fillers may include, but are not limited to, hydroxyethyl cellulose polymer, hydroxypropyl methyl cellulose, cellulose acetate, cellulose nitrate, hydroxyethyl methyl cellulose, ethyl cellulose, methylcellulose, natural tree rubber latex, synthetic rubber (e.g., polybutadiene), and hot-melt branched polystyrene-block-polybutadiene, 30% styrene, 80% diblock, polysulfide polymers, the like, and any combination thereof.

A volume ratio of the A-side to the B-side may be about 5:1 to about 1:2 (or about 5:1 to about 2:1, or about 3:1 to about 1:2). The ratio of the A-side to the B-side may depend on the mixing and placement method used when producing the foamed PIR/PUR composition. For example, in a spray foam method, the volume ratio of the A-side to the B-side may preferably be about 2:1 to about 1:2. In another example, in injection foam or pour foam method, volume ratios across the entire range of about 5:1 to about 1:2 may be applicable.

### Example Embodiments

Embodiment 1. A polyisocyanurate or polyurethane (PIR/PUR) foam formulation comprising: (a) an A-side comprising an isocyanate; and (b) a B-side comprising water; a polyol composition; a catalyst; and a blowing agent, wherein (i) the A-side further comprises about 0.1 wt % to about 10 wt %, based on the A-side, of polymeric microspheres, (ii) the B-side further comprises about 0.1 wt % to about 10 wt %, based on the B-side, of polymeric microspheres, or (iii) both (i) and (ii).

Embodiment 2. The PIR/PUR foam formulation of Embodiment 1, wherein the polymeric microspheres comprise a volatile component encapsulated in a polymer shell.

Embodiment 3. The PIR/PUR foam formulation of Embodiment 2, wherein the polymer shell comprises an acrylonitrile copolymer.

Embodiment 4. The PIR/PUR foam formulation of Embodiment 2, wherein the polymer shell comprises an acrylonitrile acrylic ester olefin copolymer.

Embodiment 5. The PIR/PUR foam formulation of Embodiment 2, wherein the volatile component comprises a C₃-7 hydrocarbon.

Embodiment 6. The PIR/PUR foam formulation of any preceding Embodiment, wherein the polymeric microspheres have a number average diameter of about 1 μm to about 100 μm.

Embodiment 7. The PIR/PUR foam formulation of any preceding Embodiment, wherein the polymeric microspheres are capable of an expanded number average diameter of about 25 μm to about 300 μm.

Embodiment 8. The PIR/PUR foam formulation of any preceding Embodiment, wherein the isocyanate comprises a polyisocyanate.

Embodiment 9. The PIR/PUR foam formulation of any preceding Embodiment, wherein the polyol composition comprises one or more polyols selected from the group consisting of a glycerin-sucrose polyol, a Mannich polyol, and an aromatic polyester polyol.

Embodiment 10. The PIR/PUR foam formulation of any preceding Embodiment, wherein the A-side and/or the B-side further comprises one or more of: surfactants, foam promoters, opacifiers, pigments, accelerators, foam stabilizers, color indicators, gelling agents, flame retardants, biocides, fungicides, algaecides, corrosion inhibitors, fillers, antioxidants, odor scavengers, pest inhibitors, chain extenders, epoxy resins, or acrylic resins.

Embodiment 11. A method comprising: mixing the A-side and the B-side of the PIR/PUR foam formulation of any preceding Embodiment; depositing (spraying, pouring, or injecting) the mixture on a surface; and allowing components of the A-side and the B-side to react to produce a foamed PIR/PUR composition comprising a PIR/PUR foam having expanded polymeric microspheres dispersed therein.

Embodiment 12. The method of Embodiment 11, wherein the PIR/PUR foam is an open-cell PIR/PUR foam.

Embodiment 13. The method of any of Embodiments 11-12, wherein the expanded polymeric microspheres are present at about 0.05 wt % to about 8 wt % based on the foamed PIR/PUR composition.

Embodiment 14. The method of any of Embodiments 11-13, wherein the expanded polymeric microspheres have a number average diameter of about 10 μm to about 300 μm.

Embodiment 15. The method of any of Embodiments 12-14, wherein the foamed PIR/PUR composition has an R-value of about 3.5 per inch to about 10 per inch.

Embodiment 16. The method of any of Embodiments 12-15, wherein the foamed PIR/PUR composition has an R-value increase of about 2% or more relative to a comparable foamed PIR/PUR composition not having the polymeric microspheres.

Embodiment 17. The method of any of Embodiments 12-16, wherein the foamed PIR/PUR composition has an apparent density of about 0.5 lb/ft³ to about 5 lb/ft³.

Embodiment 18. The method of any of Embodiments 12-17, wherein the foamed PIR/PUR composition has a compressive strength of about 2 psi to about 100 psi.

Embodiment 19. The method of any of Embodiments 12-18, wherein the foamed PIR/PUR composition has a compressive strength increase of about 5% or more relative to a comparable foamed PIR/PUR composition not having the polymeric microspheres.

Embodiment 20. A foamed polyisocyanurate or polyurethane (PIR/PUR) composition comprising: a PIR/PUR foam having expanded polymeric microspheres dispersed therein.

Embodiment 21. The foamed PIR/PUR composition of Embodiment 20, wherein the expanded polymeric microspheres are present at about 0.05 wt % to about 8 wt % based on the foamed PIR/PUR composition.

Embodiment 22. The foamed PIR/PUR composition of any of Embodiments 20-21, wherein the polymeric microspheres have a number average diameter of about 10 μm to about 300 μm.

Embodiment 23. The foamed PIR/PUR composition of any of Embodiments 20-22, wherein the foamed PIR/PUR composition has an R-value of about 3.5 per inch to about 10 per inch.

Embodiment 24. The foamed PIR/PUR composition of any of Embodiments 20-23, wherein the foamed PIR/PUR composition has an R-value increase of about 2% or more relative to a comparable foamed PIR/PUR composition not having the polymeric microspheres.

Embodiment 25. The foamed PIR/PUR composition of any of Embodiments 20-24, wherein the foamed PIR/PUR composition has an apparent density of about 0.5 lb/ft³ to about 5 lb/ft³.

Embodiment 26. The foamed PIR/PUR composition of any of Embodiments 20-25, wherein the foamed PIR/PUR composition has a compressive strength of about 2 psi to about 100 psi.

Embodiment 27. The foamed PIR/PUR composition of any of Embodiments 20-26, wherein the foamed PIR/PUR composition has a compressive strength increase of about 5% or more relative to a comparable foamed PIR/PUR composition not having the polymeric microspheres.

Embodiment 28. The foamed PIR/PUR composition of any of Embodiments 20-27 further comprising: one or more of: surfactants, foam promoters, opacifiers, pigments, accelerators, foam stabilizers, color indicators, gelling agents, flame retardants, biocides, fungicides, algaecides, corrosion inhibitors, fillers, antioxidants, odor scavengers, pest inhibitors, chain extenders, epoxy resins, or acrylic resins.

Embodiment 29. An article comprising: a nonwoven matte having a foamed polyisocyanurate or polyurethane (PIR/PUR) composition implanted therein, the foamed PIR/PUR composition comprising a PIR/PUR foam having expanded polymeric microspheres dispersed therein.

Embodiment 30. An article comprising: two substrates; and a foamed polyisocyanurate or polyurethane (PIR/PUR) composition between the two substrates, the foamed PIR/PUR composition comprising a PIR/PUR foam having expanded polymeric microspheres dispersed therein.

Embodiment 31. The article of any of Embodiments 29-30, wherein the expanded polymeric microspheres are present at about 0.05 wt % to about 8 wt % based on the foamed PIR/PUR composition.

Embodiment 32. The article of any of Embodiments 29-31, wherein the polymeric microspheres have a number average diameter of about 10 μm to about 300 μm.

Embodiment 33. The article of any of Embodiments 29-32, wherein the foamed PIR/PUR composition has an R-value of about 3.5 per inch to about 10 per inch.

Embodiment 34. The article of any of Embodiments 29-33, wherein the foamed PIR/PUR composition has an R-value increase of about 2% or more relative to a comparable foamed PIR/PUR composition not having the polymeric microspheres.

Embodiment 35. The article of any of Embodiments 29-34, wherein the foamed PIR/PUR composition has an apparent density of about 0.5 lb/ft³ to about 5 lb/ft³.

Embodiment 36. The article of any of Embodiments 29-35, wherein the foamed PIR/PUR composition has a compressive strength of about 2 psi to about 100 psi.

Embodiment 37. The article of any of Embodiments 29-36, wherein the foamed PIR/PUR composition has a compressive strength increase of about 5% or more relative to a comparable foamed PIR/PUR composition not having the polymeric microspheres.

Embodiment 38. The article of any of Embodiments 29-37 further comprising: one or more of: surfactants, foam promoters, opacifiers, pigments, accelerators, foam stabilizers, color indicators, gelling agents, flame retardants, biocides, fungicides, algaecides, corrosion inhibitors, fillers, antioxidants, odor scavengers, pest inhibitors, chain extenders, epoxy resins, or acrylic resins.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the incarnations of the present inventions. At the very least, and not as an attempt to limit the application of the doctrine of equivalents to the scope of the claim, each numerical parameter should at least be construed in light of the number of reported significant digits and by applying ordinary rounding techniques.

One or more illustrative incarnations incorporating one or more invention elements are presented herein. Not all features of a physical implementation are described or shown in this application for the sake of clarity. It is understood that in the development of a physical embodiment incorporating one or more elements of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### Examples

Samples of foamed compositions with and without polymeric microspheres (EXPANCEL polymeric microspheres having an unexpanded diameter of about 10 μm to about 16 μm and including a C4-C6 alkane within a polymer shell) were prepared using the foam formulations described in Table 1, in which the components of the B-side of each formulation are reported in weight percent (wt %) based on a total weight of the B-side. The A-side of each formulation included PMDI. The A-side and B-side were provided at an approximately 1:1 weight ratio for each formulation. Each of the samples (S1, S2, and S3) included polymeric microspheres, whereas the corresponding control samples (C1, C2, and C3) did not include the polymeric microspheres.

TABLE 1

| | C1 | S1 | C2 | S2 | C3 | S3 |
|---|---|---|---|---|---|---|
| Polyether polyol | 34.0 | 33.0 | 20.5 | 19.9 | — | — |
| Aromatic polyester polyol | — | — | 25.0 | 24.3 | 36.4 | 35.3 |
| Aromatic amino polyether | — | — | 15.0 | 14.5 | 31.0 | 30.1 |
| polyol | | | | | | |
| HFO Blowing Agent | — | — | 5.0 | 4.9 | 10.0 | 9.7 |
| NPE Emulsifier | 11.9 | 11.5 | 10.0 | 9.7 | — | — |
| Water | 20.0 | 19.4 | 4.0 | 3.9 | 2.0 | 1.9 |
| TCPP | 25.2 | 24.5 | 15.0 | 14.5 | 16.0 | 15.5 |
| Silicone surfactant | 1.0 | 1.0 | 1.2 | 1.1 | 1.0 | 1.0 |
| Amine catalyst | 7.9 | 7.6 | 4.0 | 3.9 | 3.6 | 3.5 |
| Metal catalyst | — | — | 0.3 | 0.3 | — | — |
| Polymeric microspheres | — | 3.0 | — | 3.0 | — | 3.0 |

Foamed compositions from each of the foam formulations were prepared. Table 2 provides the physical properties and reference to scanning electron microscopy (SEM) images for the samples.

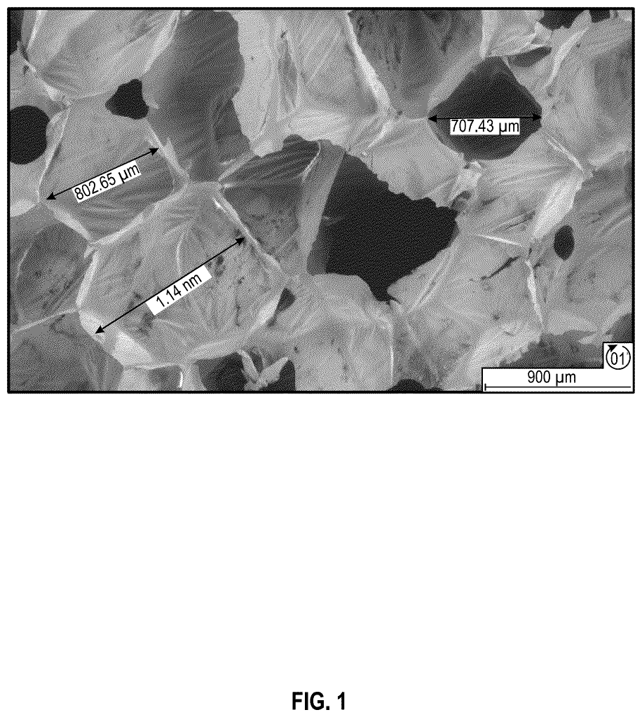

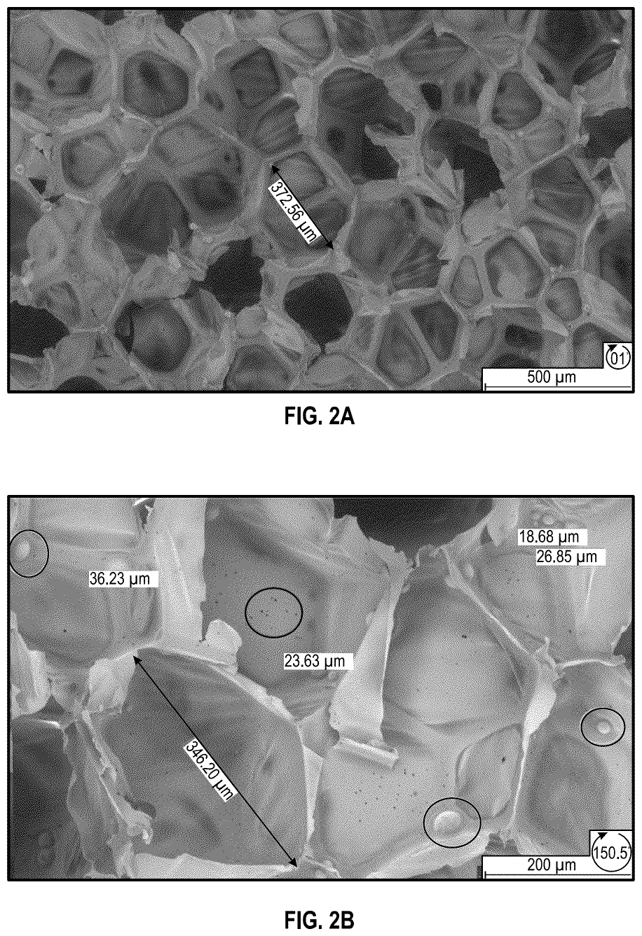

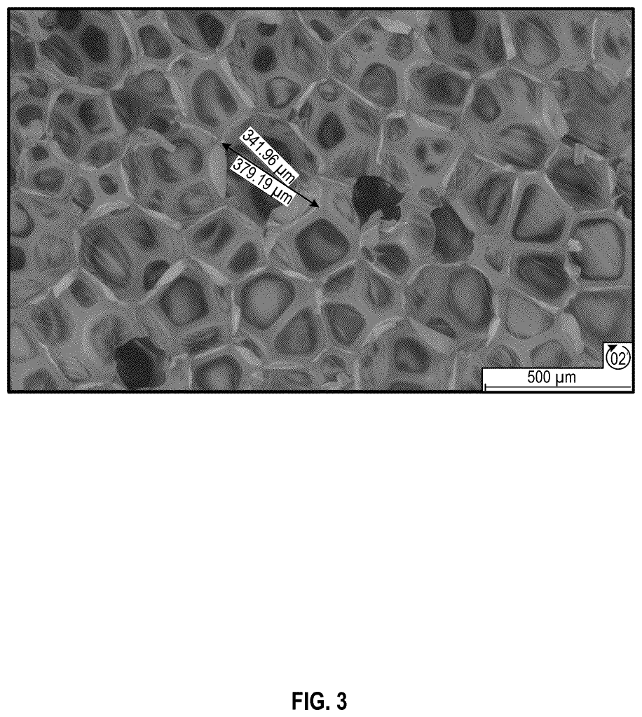

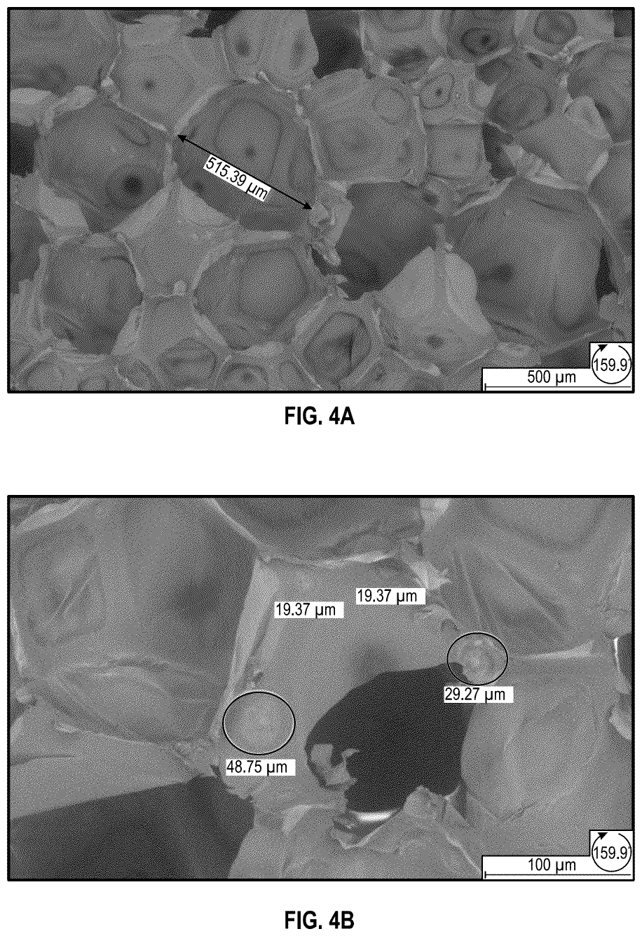

TABLE 2

| | Comp. | Comp. | | R-value | |
|---|---|---|---|---|---|
| | Strength | Strength | R-value | Increase | |
| Sample | (psi) | Increase (%) | (per inch) | (%) | FIGS. |
| Control 1 | 3.8 | n/a | 3.8 | n/a | FIG. 1 |
| Sample 1 | 4.2 | 11 | 3.9 | 3 | FIGS. 2A-2B |
| Control 2 | 21 | n/a | 6.2 | n/a | FIG. 3 |
| Sample 2 | 27 | 29 | N.M. | n/a | FIGS. 4A-4B |
| Control 3 | 38 | n/a | 7.2 | n/a | — |
| Sample 3 | N.M. | n/a | 7.6 | 6 | — |

N.M.—not measured

Analysis of the SEM images produced the following observations. Control 1 had a mixture of open and closed cells ranging in diameter from about 700 μm to about 1 mm. Sample 1 had a mixture of open and closed cells ranging in diameter from about 300 μm to about 700 μm and expanded polymeric microspheres having diameters ranging from about 10 μm to about 30 μm. Control 2 had a mixture of open and closed cells ranging in diameter from about 250 μm to about 400 μm. Sample 2 had a mixture of open and closed cells ranging in diameter from about 250 μm to about 500 μm and expanded polymeric microspheres having diameters ranging from about 20 μm to about 50 μm.

Therefore, the present invention is well adapted to attain the ends and advantages mentioned as well as those that are inherent therein. The particular examples and configurations disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative examples disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A polyisocyanurate or polyurethane (PIR/PUR) foam formulation comprising:
(a) an A-side comprising an isocyanate; and
(b) a B-side comprising water; a polyol composition; a catalyst; and a blowing agent,
wherein (i) the A-side further comprises about 0.1 wt % to about 10 wt %, based on the A-side, of polymeric microspheres, (ii) the B-side further comprises about 0.1 wt % to about 10 wt %, based on the B-side, of polymeric microspheres, or (iii) both (i) and (ii).

2. The PIR/PUR foam formulation of claim 1, wherein the polymeric microspheres comprise a volatile component encapsulated in a polymer shell.

3. The PIR/PUR foam formulation of claim 2, wherein the polymer shell comprises an acrylonitrile copolymer.

4. The PIR/PUR foam formulation of claim 2, wherein the polymer shell comprises an acrylonitrile acrylic ester olefin copolymer.

5. The PIR/PUR foam formulation of claim 2, wherein the volatile component comprises a C₃-7 hydrocarbon.

6. The PIR/PUR foam formulation of claim 1, wherein the polymeric microspheres have a number average diameter of about 1 μm to about 100 μm.

7. The PIR/PUR foam formulation of claim 1, wherein the polymeric microspheres are capable of an expanded number average diameter of about 25 μm to about 300 μm.

8. The PIR/PUR foam formulation of claim 1, wherein the isocyanate comprises a polyisocyanate.

9. The PIR/PUR foam formulation of claim 1, wherein the polyol composition comprises one or more polyols selected from the group consisting of a glycerin-sucrose polyol, a Mannich polyol, and an aromatic polyester polyol.

10. The PIR/PUR foam formulation of claim 1, wherein the A-side and/or the B-side further comprises one or more of: surfactants, foam promoters, opacifiers, pigments, accelerators, foam stabilizers, color indicators, gelling agents, flame retardants, biocides, fungicides, algaecides, corrosion inhibitors, fillers, antioxidants, odor scavengers, pest inhibitors, chain extenders, epoxy resins, or acrylic resins.

11. A method comprising:
mixing the A-side and the B-side of the PIR/PUR foam formulation of claim 1;
depositing the mixture on a surface; and
allowing components of the A-side and the B-side to react to produce a foamed PIR/PUR composition comprising a PIR/PUR foam having expanded polymeric microspheres dispersed therein.

12. The method of claim 11, wherein the PIR/PUR foam is an open-cell PIR/PUR foam.

13. The method of claim 11, wherein the expanded polymeric microspheres are present at about 0.05 wt % to about 8 wt % based on the foamed PIR/PUR composition.

14. The method of claim 11, wherein the expanded polymeric microspheres have a number average diameter of about 10 μm to about 300 μm.

15. The method of claim 11, wherein (i) the foamed PIR/PUR composition has an R-value of about 3.5 per inch to about 10 per inch and/or (ii) the foamed PIR/PUR composition has an R-value increase of about 2% or more relative to a comparable foamed PIR/PUR composition not having the polymeric microspheres.

16. The method of claim 11, wherein the foamed PIR/PUR composition has an apparent density of about 0.5 lb/ft³ to about 5 lb/ft³.

17. The method of claim 11, wherein (i) the foamed PIR/PUR composition has a compressive strength of about 2 psi to about 100 psi and/or (ii) the foamed PIR/PUR composition has a compressive strength increase of about 5% or more relative to a comparable foamed PIR/PUR composition not having the polymeric microspheres.

18. A foamed polyisocyanurate or polyurethane (PIR/PUR) composition comprising:
a PIR/PUR foam having expanded polymeric microspheres dispersed therein.

19. An article comprising:
a nonwoven matte having the foamed PIR/PUR composition of claim 18 implanted therein.

20. An article comprising:
two substrates; and
the foamed PIR/PUR composition of claim 18 between the two substrates.
